(19) United States
(12) Patent Application Publication
(10) Pub. No.: US 2013/0262184 A1
(43) Pub. Date: Oct. 3, 2013

(54) Systems and Methods for Presence Detection and Linking to Media Exposure Data

(71) Applicant: ARBITRON INC., Columbia, MD (US)

(72) Inventors: Anand Jain, Ellicott City, MD (US); John Stavropoulos, Edison, NJ (US); Alan Neuhauser, Silver Spring, MD (US); Wendell Lynch, East Lansing, MI (US); Vladimir Kuznetsov, Ellicott City, MD (US); Jack Crystal, Owings Mills, MD (US); David Gish, Riverdale, NJ (US)

(73) Assignee: ARBITRON INC., Columbia, MD (US)

(21) Appl. No.: 13/729,889

(22) Filed: Dec. 28, 2012

Related U.S. Application Data
(63) Continuation-in-part of application No. 13/435,433, filed on Mar. 30, 2012.

(51) Int. Cl. G06Q 30/02

(52) U.S. Cl. CPC G06Q 30/0205
USPC 705/7.34

(57) ABSTRACT

A computer-implemented system, apparatus and method for monitoring media exposure data and correlating media exposure data to locations. Location data may be generated utilizing measurements of radio waves from WiFi and/or Bluetooth. Identification may also be transmitted when WiFi and/or Bluetooth transmission are received. As media is reproduced or received on/near a portable device, media exposure data is generated. Subsequent location data is monitored and processed to determine specific locations that may include commercial establishments. The locations are then correlated to the media exposure data to determine user actions related to media exposure.

### RELATED APPLICATIONS

The present disclosure is a continuation-in-part of U.S. patent application Ser. No. 13/435,433, titled Systems and Methods for Wirelessly Modifying Detection Characteristics of Portable Devices” to Jain et al, filed Oct. 22, 2012, the contents of which is incorporated by reference in its entirety herein.

### TECHNICAL FIELD

The present disclosure is directed to processor-based audience analytics. More specifically, the disclosure describes systems and methods for utilizing wireless data signals to determine portable device location and linking location data to media exposure data.

### BACKGROUND INFORMATION

Wireless technology such as Bluetooth and Wi-Fi has become an important part of data transfer for portable processing devices. Bluetooth is a proprietary open wireless technology standard for exchanging data over short distances from fixed and mobile devices, creating personal area networks (PANs) with high levels of security. Bluetooth uses a radio technology called frequency-hopping spread spectrum, which divides the data being sent and transmits portions of it on up to 79 bands (1 MHz each, preferably centered from 2402 to 2480 MHz) in the range 2,400-2,483.5 MHz (allowing for guard bands). This range is in the globally unlicensed Industrial, Scientific and Medical (ISM) 2.4 GHz short-range radio frequency band. Gaussian frequency-shift keying (GFSK) modulation may be used, however, more advanced techniques, such as π/4-DQPSK and 8 DPSK modulation may also be used between compatible devices. Devices functioning with GFSK are said to be operating in “basic rate” (BR) mode where an instantaneous data rate of 1 Mbit/s is possible. “Enhanced Data Rate” (EDR) is used to describe π/4-DPSK and 8 DPSK schemes, each giving 2 and 3 Mbit/s respectively. The combination of these (BR and EDR) modes in Bluetooth radio technology is classified as a “BR/EDR radio”.

However, technologies such as Bluetooth and WiFi have been underutilized in the areas of location tracking and media exposure measurement. One area where improvements are needed is in the area of media exposure tracking and web analytics. What is needed are methods, systems and apparatuses for utilizing WiFi and Bluetooth signals for location tracking and correlating the location tracking to media exposure. It has been found that WiFi and/or Bluetooth communications (i.e., radio wave communication) may be used to advantageously determine locations of portable devices, particularly in indoor environments. Such location tracking would be particularly valuable in determining user actions in connection with media exposure.

### SUMMARY

Accordingly, apparatuses, systems and methods are disclosed for correlating location data with media exposure. Under one exemplary embodiment, a computer-implemented method for correlating media exposure data with location data for a portable processing device is disclosed, where the method comprises the steps of: receiving the media exposure data in a processing device, the media exposure data representing media that was one of received and reproduced on or near the portable processing device; processing the media exposure data to determine at least one characteristic of the media; receiving location data from the portable processing device over a predetermined time period, wherein the location data is based on radio wave measurements; processing the location data to determine at least one identification for at least some of the location data; and processing the identification in the processing device to determine a correlation between the at least one identification and the determined characteristic.

Under another exemplary embodiment, a system is disclosed for correlating media exposure data with location data for a portable processing device, comprising: an input for receiving the media exposure data, the media exposure data representing media that was one of received and reproduced on or near the portable processing device, wherein the input is configured to receive location data from the portable processing device over a predetermined time period, wherein the location data is based on radio wave measurements; a processor, operatively coupled to the input, said processor being configured to: process the media exposure data to determine at least one characteristic of the media, process the location data to determine at least one identification for at least some of the location data, and process the identification to determine a correlation between the at least one identification and the determined characteristic.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary system under one embodiment, where media data is provided from a network to a processing device in the vicinity of a plurality of portable devices;

FIG. 2 illustrates an exemplary Bluetooth protocol stack utilized for communication;

FIG. 3 illustrates an exemplary service discovery process;

FIG. 4 illustrates an exemplary authentication mechanism for connected devices;

FIG. 5 is an exemplary flowchart for monitoring an RSSI Bluetooth signal characteristic;

FIG. 6 illustrates an exemplary block diagram of a portable device utilized in the present disclosure;

FIG. 7 illustrates another exemplary embodiment of a portable device configured to monitor media data communicating with a plurality of wireless transmitters;

FIG. 8 is an exemplary flow diagram of wireless transmitter communication for a portable device under one embodiment;

FIG. 9 is an exemplary embodiment for location tracking for a processing device containing a location module;

FIG. 10 is another exemplary embodiment for media exposure and location linking; and

FIG. 10A is an exemplary embodiment of a general or local visit to a location using the configuration of FIG. 10.

### DETAILED DESCRIPTION

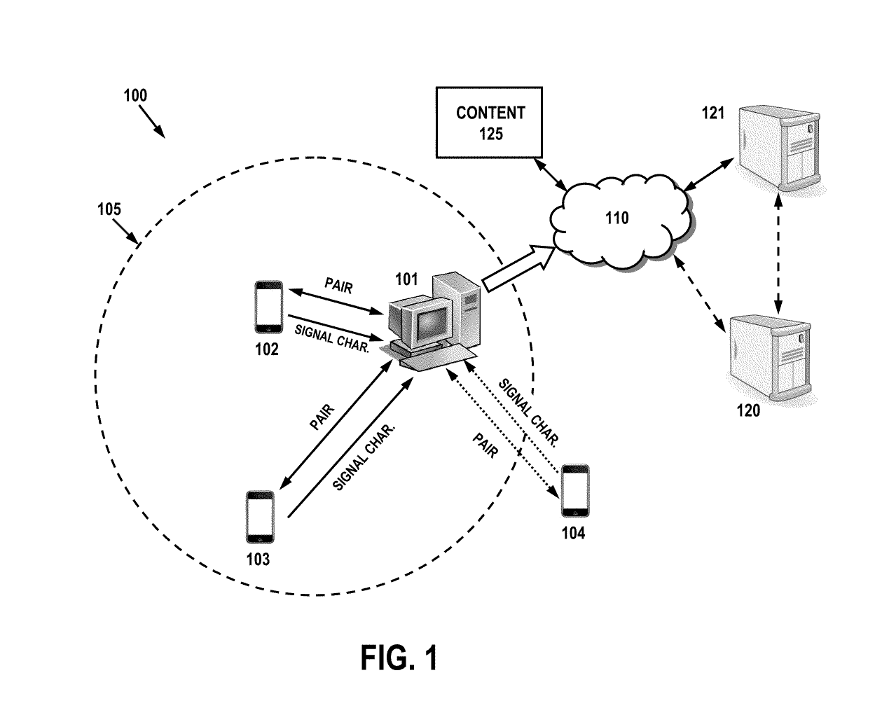

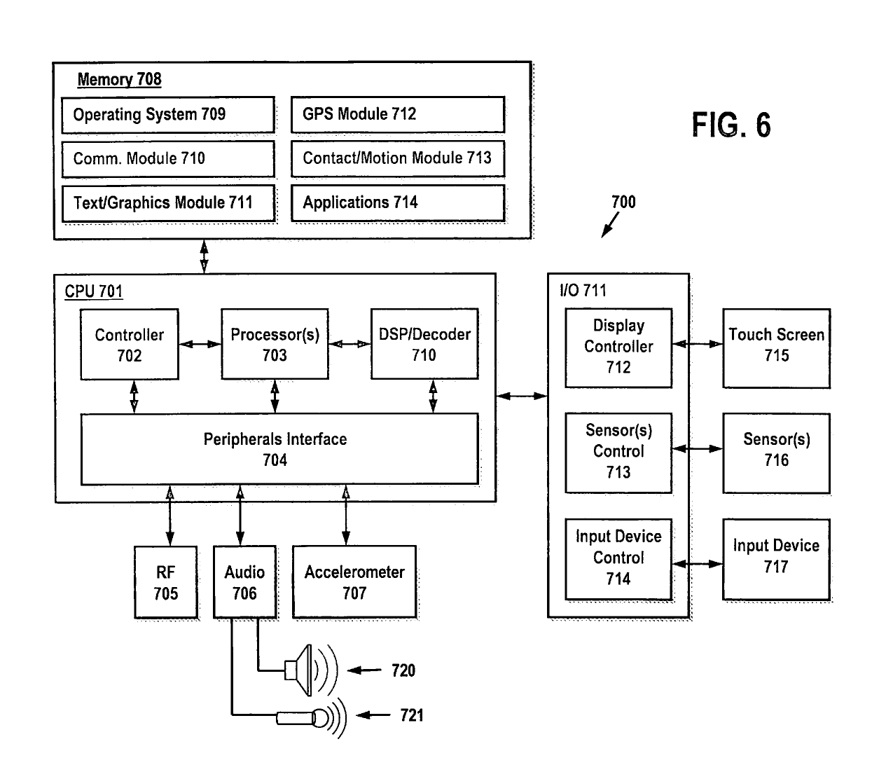

The present disclosure generally deals with the collection of research data relating to media and media data from portable computing devices using wireless technologies, such as Bluetooth and Wi-Fi. Additionally, the present disclosure deals with configuring portable computing devices for the collection of research data using wireless technologies. Regarding collection of research data, FIG. 1 illustrates an exemplary system 100 that comprises a computer processing device 101 and a plurality of portable computing devices (102-104) that are in the vicinity of processing device 101. In this example, processing device 101 is illustrated as a personal computer, while portable computing devices 102-104 are illustrated as Bluetooth-enabled, Wi-Fi-enabled, or other wirelessly-enabled cell phones. One example of a portable computing device is illustrated below in connection with FIG. 6. It is understood by those skilled in the art that other similar devices may be used as well. For example, processing device 101 may also be a laptop, a computer tablet, a set-top box, a media player, a network-enabled television or DVD player, and the like. Portable computing devices 102-104 may also be laptops, PDAs, tablet computers, Personal People Meters™ (PPMs), wireless telephone, etc.

Under a preferred embodiment, processing device 101 connects to content source 125 via network 110 to obtain media data. The terms “media data” and “media” as used herein mean data which is widely accessible, whether over-the-air, or via cable, satellite, network, internetwork (including the Internet), displayed, distributed on storage media, or by any other means or technique that is humanly perceptible, without regard to the form or content of such data, and including but not limited to audio, video, audio/video, text, images, animations, databases, broadcasts, displays (including but not limited to video displays), web pages and streaming media. As media is received on processing device 101, analytics software residing on processing device 101 collects information relating to media data received from content source 125, and additionally may collect data relating to network 110.

Data relating to the media data may include a “cookie”, also known as an HTTP cookie, which can provide state information (memory of previous events) from a user's browser and return the state information to a collecting site, which may be the content source 125 or collection site 121 (or both). The state information can be used for identification of a user session, authentication, user's preferences, shopping cart contents, or anything else that can be accomplished through storing text data on the user's computer.

Referring back to the example of FIG. 1, media data is received on processing device 101. At the time the media data is received, portable computing devices 102-104 are in the vicinity, and are configured to establish Bluetooth communication (“pair”) with processing device 101. After Bluetooth communications are established, processing device 101 collects the Bluetooth signal characteristics from each portable computing device. Under a preferred embodiment, Bluetooth signal characteristics relate to status parameters of a Bluetooth connection together with any other signal strength values made available in Bluetooth Core Specification. The Host Controller Interface (HCI) (discussed in greater detail below) provides access to three such connection status parameters, including Link Quality (LQ), Received Signal Strength Indicator (RSSI), and Transmit Power Level (TPL). All these status parameters require the establishment of an active Bluetooth connection in order to be measured. Another signal parameter, referred to as “Inquiry Result with RSSI”, alternately also be used, where the parameter perceives RSSI from the responses sent by its nearby devices.

Briefly, Link Quality (LQ) is an 8-bit unsigned integer that evaluates the perceived link quality at the receiver. It ranges from 0 to 255, where the larger the value, the better the link's state. For most Bluetooth modules, it is derived from the average bit error rate (BER) seen at the receiver, and is constantly updated as packets are received. Received Signal Strength Indicator (RSSI) is an 8-bit signed integer that denotes received (RX) power levels and may further denote if the level is within or above/below the Golden Receiver Power Range (GRPR), which is regarded as the ideal RX power range. As a simplified example, when multipath propagation is present, RSSI is generally based on a line-of-sight (LOS) field strength and a reflected signal strength, where the overall strength is proportional to the magnitude of the electromagnetic wave's E-field. Thus, when there is minimal reflective interference, RSSI may be determined by 20 log (LOS+RS), where LOS is the line-of-sight signal strength and RS is the reflected signal. When reflective interference is introduced RSSI becomes 20 log (LOS−RS).

Transmit Power Level (TPL) is an 8-bit signed integer which specifies the Bluetooth module's transmit power level (in dBm). Although there are instances when a transmitter will use its device-specific default power setting to instigate or answer inquiries, its TPL may vary during a connection due to possible power control. “Inquiry Result with RSSI” works in a similar manner as a typical inquiry. In addition to the other parameters (e.g., Bluetooth device address, clock offset) generally retrieved by a normal inquiry, it also provides the RSSI value. Since it requires no active connection, the radio layer simply monitors the RX power level of the current inquiry response from a nearby device, and infers the corresponding RSSI.

For system 100, transmission may occur from direct voltage controlled oscillator (VCO) modulation to IQ mixing at the final radio frequency (RF). In the receiver, a conventional frequency discriminator or IQ down-conversion combined with analog-to-digital conversion is used. The Bluetooth configuration for each of the portable computing devices 102-104 and processing device 101 include a radio unit, a baseband link control unit, and link management software. Higher-level software utilities focusing on interoperability features and functionality are included as well. Enhanced Data Rate (EDR) functionalities may also be used to incorporate phase shift keying (PSK) modulation scheme to achieve a data rate of 2 or 3 Mb/s. It allows greater possibilities for using multiple devices on the same connection because of the increased bandwidth. Due to EDR having a reduced duty cycle, there is lower power consumption compared to a standard Bluetooth link.

As mentioned above, processing device 101 collects the Bluetooth signal characteristics from each portable computing device (102-104). At the same time, processing device 101 is equipped with software and/or hardware allowing it to measure media data exposure for a given period of time (e.g., digital signage, QR scan, a web browsing session, etc.) to produce research data. The term “research data” as used herein means data comprising (1) data concerning usage of media data, (2) data concerning exposure to media data, and/or (3) market research data. Under a preferred embodiment, when processing device 101 detects media data activity, it triggers a timer task to run for a predetermined period of time (e.g., X minutes) until the activity is over. At this time, discovery of paired devices is performed to locate each of the paired devices. Preferably, the UIDs of each device is known in advance. For each device discovered and paired, processing device 101 records each Bluetooth signal characteristic for the connection until the end of the session. Afterwards, the signal characteristics collected for each device, and the resultant research data for the session is forwarded to collection server 121 for further processing and/or analysis. Collection server 121 may further be communicatively coupled to server 120 which may be configured to provide further processing and/or analysis, generate reports, provide content back to processing device 101, and other functions. Of course, these functions can readily be incorporated into collection server 121, depending on the needs and requirements of the designer.

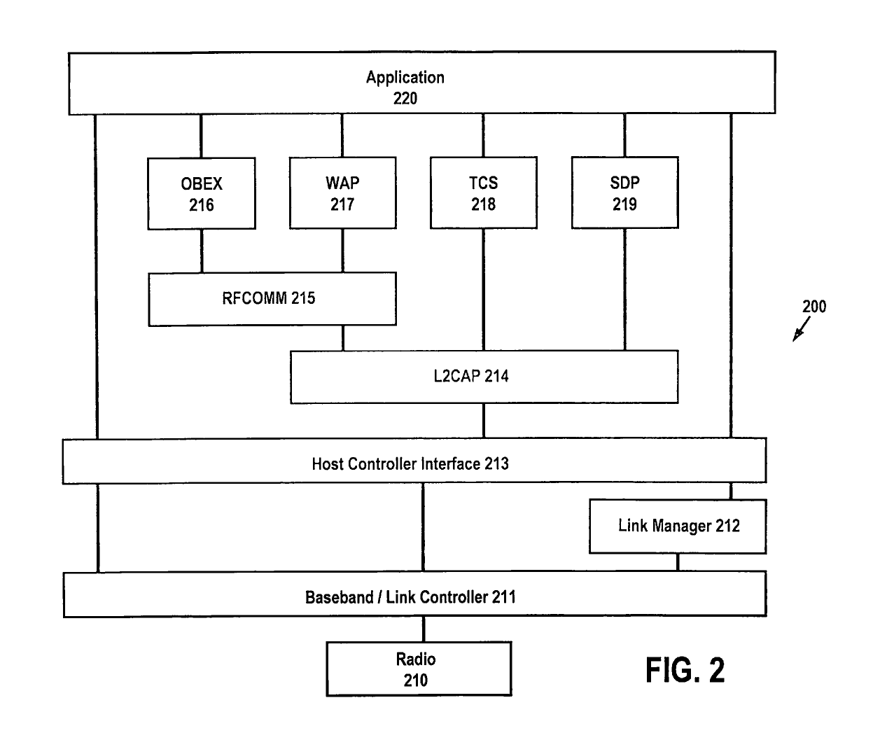

FIG. 2 shows an exemplary Bluetooth protocol stack utilized for communication in the embodiment of FIG. 1. Generally, the transition from implementation in hardware and firmware (lower layers) to software (higher layers). If each of these groups of layers are separate entities, such as a PC card and laptop computer, then they can communicate with each other through Host Controller Interface 213 (HCI), which provides paths for data, audio, and control signals between the Bluetooth module and host.

Radio 210 completes the physical layer by providing a transmitter and receiver for two-way communication. Data packets are assembled and fed to the radio 210 by the baseband/link controller 211. The link controller of 211 provides more complex state operations, such as the standby, connect, and low-power modes. The baseband and link controller functions are combined into one layer to be consistent with their treatment in the Bluetooth Specification. Link manager 212 provides link control and configuration through a low-level language called the link manager protocol (LMP).

Logical link control and adaptation protocol (L2CAP) 214 establishes virtual channels between hosts that can keep track of several simultaneous sessions such as multiple file transfers. L2CAP 214 also takes application data and breaks it into Bluetooth-size portions for transmission, and reverses the process for received data. Radio Frequency Communication (RFCOMM) 215 is a Bluetooth serial port emulator, and its main purpose is to “trick” application 220 into thinking that a wired serial port exists instead of an RF link. Finally, various software programs that are needed for different Bluetooth usage models enable resident application 220 to use Bluetooth. These include service discovery protocol (SDP) 219, object exchange (OBEX), 216 telephony control protocol specification (TCS) 218, and Wireless Application Protocol (WAP) 217. Bluetooth radio 210 and baseband/link controller 211 consist of hardware that is typically available as one or two integrated circuits. Firmware-based link manager 212 and one end of the host controller interface 213, perhaps with a bus driver for connection to the host, complete the Bluetooth module shown in FIG. 2. The remaining parts of tile protocol stack and the host end of HCI 213 can be implemented in software on the host itself.

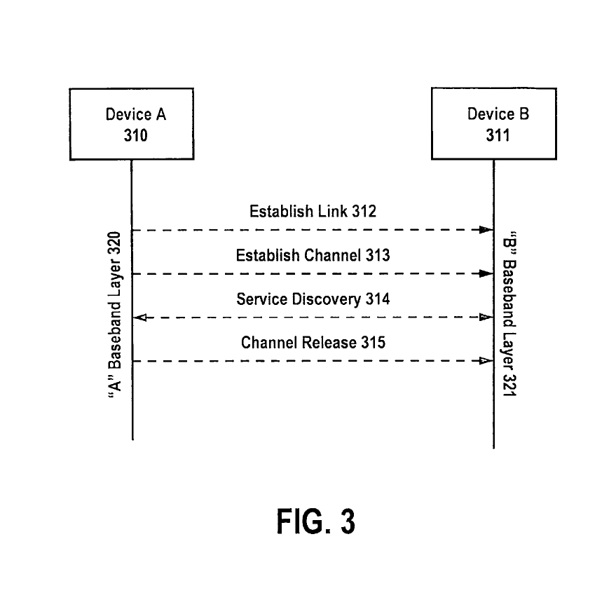

FIG. 3 illustrates an exemplary Bluetooth discovery process utilizing “Device A” 310 and “Device B” 311 using each respective baseband layer (320, 321). Here, Device A 310 is initiating service discover while Device B 311 establishes communications in order to make it discoverable. The process may be assisted using a service discovery application from an access profile stored in each device.

The initial linking process 312 begins with an inquiry and page among devices in order to establish a piconet. In FIG. 3, Device A 310 is configured as a prospective slave (p-slave) and Device B 311 is a prospective master (p-master). As a p-master, Device B 311 must send its frequency hop synchronization (FHS) packet to a Device A 310 so the latter can use the same hop sequence and phase used by the master. Preferably, a predetermined hop sequence or set of sequences, are used for paging and inquiries. For inquiries, the p-master may not know about nearby devices, so a single common hop sequence (one sequence for sending an inquiry and another for responding to the inquiry) is used by all devices for initial device discovery. A p-slave responding to an inquiry sends its FHS packet, within which is its Bluetooth device address (BD_ADDR) which may be used for further piconet and scattenet identification. Now the p-master can create a new hopping sequence based the BD_ADDR for transmitting a subsequent page for establishing a piconet with that p-slave.

Inquiries that are sent and replied by a device are typically transmitted at a device-specific default power setting. As a result, signal characteristics, such RSSI collected through an inquiry is relatively free from the side-effect of power control. Accordingly, a inquiry fetched RSSI may provide finer measurements than the connection-based RSSI.

For establishing channel 313, a hop channel set and the sequence of hops through the channel set may be determined by the lower 28 bits of a device's BD_ADDR, and the hop phase may be determined by the 27 most significant bits of CLK. These two values are sent to a hop generator, and the output of this generator goes to the Bluetooth radio's frequency synthesizer. In order to establish communications, Devices A and B should use the same hop channels, the same hop sequence from channel to channel, and the same phase so that they hop together. Also, one device should transmit while the other receives on the same frequency and vice versa. Multiple hop sequences and periods are configured to cover inquiry, page, and connect activity. These include channel hop sequence (used for normal piconet communications between master and slave(s)), page hop sequence (used by a p-master to send a page to a specific p-slave and to respond to the slave's reply), page response sequence (used by a p-slave to respond to a p-master's page), inquiry hop sequence (used by a p-master to send an inquiry to find Bluetooth devices in range), and inquiry response sequence (used by a p-slave to respond to a p-master's inquiry).

Service discovery 314 is used for retrieving information required to set up a transport service or usage scenario, and may also be used to access a device and retrieve its capabilities or to access a specific application and find devices that support that application. Retrieving capabilities requires paging a device and forming an Asynchronous Connectionless Link (ACL) to retrieve the desired information, accessing applications involves connecting to and retrieving information from several devices that are discovered via an inquiry. Thus, service discovery may be used for browsing for services on a particular device, searching for and discovering services based upon desired attributes, and/or incrementally searching a device's service list to limit the amount of data to be exchanged. An L2CAP channel with a protocol service multiplexer (PSM) is used for the exchange of service-related information. Service discovery can have both client and server implementations, with at most one service discovery server on any one device. However, if a device is client only, then it need not have a service discovery server. Each service is preferably listed in the device's SOP database as a service record having a unique ServiceRecordHandle, and each attribute of the service record is given an attribute ID and an attribute value. Attributes include the various classes, descriptors, and names associated with the service record. After service discovery is completed, the channel is released 315.

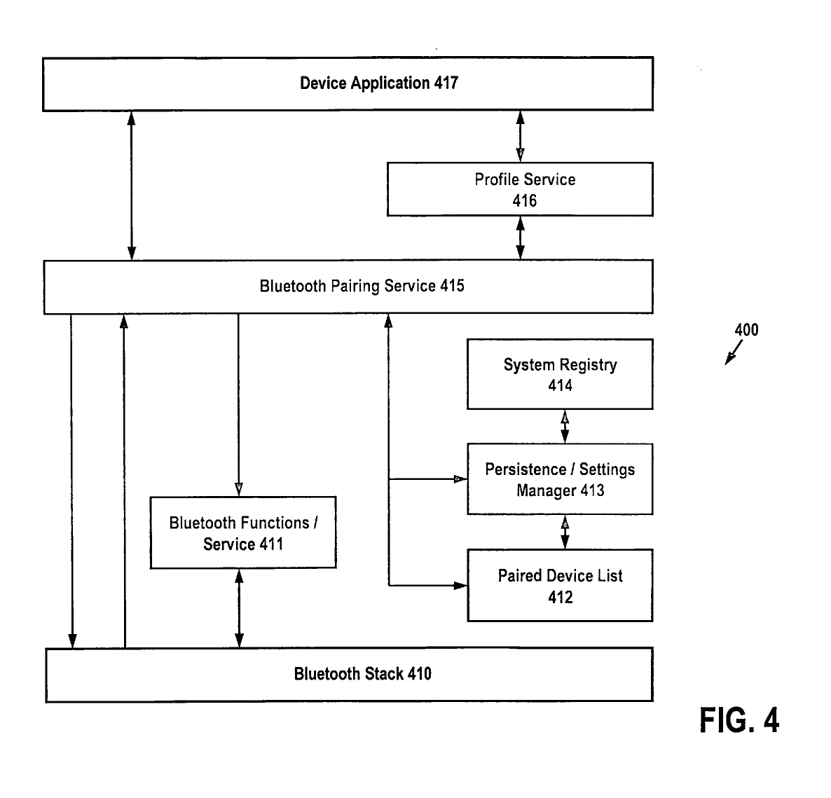

FIG. 4 illustrates an exemplary authentication configuration 400, where Bluetooth Pairing Service 415 sends API calls to Bluetooth Stack 410 and receives back pairing events. Bluetooth Stack 410 transmits API calls to Bluetooth helper service/function 411, which receives discovery enable signals (inquiry, page scan) from Bluetooth Pairing Service 415. Bluetooth pairing information for Pairing Service 415 is communicated from persistence/settings manager 413 and paired device list 412, which preferably retries information from system registry 414. Bluetooth Pairing Service 415 forwards information to device application 417, and may further retrieve and communicate profile services 416 to application 417 as well.

The authentication process verifies the identity of the device at the other end of a link. The verifier queries the claimant and checks its response; if correct, then authentication is successful. Authorization can be used to grant access to all services, a subset of services, or to some services when authentication is successful, but requires additional authentication based on some user input at the client device for further services. The last item is usually implemented at the application layer. For Bluetooth Pairing Services 415, two devices become paired when they start with the same PIN and generate the same link key, and then use this key for authenticating at least a current communication session. The session can exist for the life of a L2CAP link (for Mode 2 security) or the life of the ACL link (for Mode 3 security). Pairing can occur through an automatic authentication process if both devices already have the same stored PIN from which they can derive the same link keys for authentication. Alternatively, either or both applications can ask their respective users for manual PIN entry. Once devices are paired they can either store their link keys for use in subsequent authentications or discard them and repeat the pairing process each time they connect. If the link keys are stored, then the devices are “bonded,” enabling future authentications to occur using the same link keys and without requiring the user to input the PIN again. The concept of “trust” applies to a device's authorization to access certain services on another device. A trusted device is previously authenticated and, based upon that authentication, has authorization to access various services. An untrusted device may be authenticated, but further action is needed, such as user intervention with a password, before authorization is granted to access services. Also, encryption may be used to further enhance security of connections.

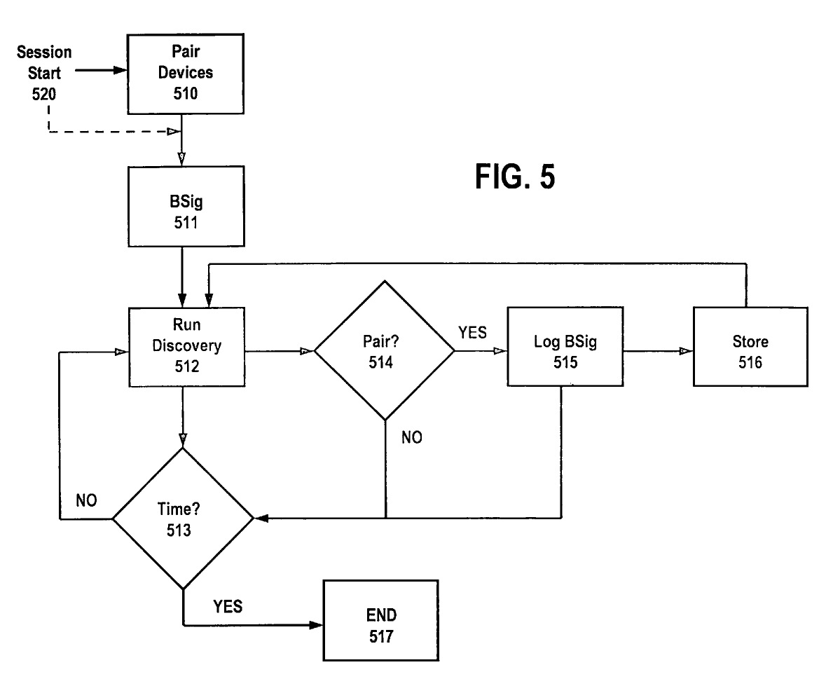

FIG. 5 discloses one exemplary process for linking exposure to media data utilizing Bluetooth signal characteristics described above. In the beginning, a web session 520 starts, which triggers Bluetooth pairing of nearby devices 510. Once paired, the Bluetooth signal characteristics 511 (“BSig”) are initially received. In the event that devices are already paired and/or bonded, the process starts by acquiring Bluetooth signal characteristics 511. Afterwards, a discovery process is run 512 for retrieving information for transport service or usage scenario, and may also be used to access a device and retrieve its capabilities or to access a specific application and find devices that support that application. Under one embodiment, a timer is used for media data exposure, wherein the timer can be set for specific time periods, or may alternately be set and used to correspond with web sessions or other events. When the timer 513 runs out, the process ends in 517. Otherwise, the process moves to 514, where the pairing is validated to ensure that a Bluetooth device is not moving out of range or otherwise compromising the connection. If the pairing validation produces a negative result, the process continues to look for the device via 512 for the time period 513. If the pairing validation is affirmative, the Bluetooth signal characteristics are logged 515 and stored 516 for the duration of the measurement (513). It should be understood that BSig block 515 may include Received Signal Strength Indicator (RSSI) value, a Transmit Power Level (TPL) value and/or a Link Quality (LQ) value

It is understood that the examples above are provided as examples, and are not intended to be limiting in any way. Under an alternate embodiment, Bluetooth signal strengths may be approximated to determine distance. As explained above, an RSSI value provides the distance between the received signal strength and an optimal receiver power rank referred to as the “golden receiver power rank.” The golden receiver power rank is limited by two thresholds. The lower threshold may be defined by an offset of 6 dB to the actual sensitivity of the receiver. The maximum of this value is predefined by −56 dBm. The upper threshold may be 20 dB over the lower one, where the accuracy of the upper threshold is about ±6 dB. Where S is assigned as the received signal strength, the value of S is determined by: (1) S=RSSI+T_{U}, for RSSI>0 and (2) S=RSSI−T_{L}, for RSSI<0, where T_{U}=T_{L}+20 DdB. Here, T_{U} refers to the upper threshold, and T_{L} refers to the lower threshold. The definition of the Bluetooth golden receiver limits the measurement of the RSSI to a distance. In order to measure the most unique characteristics of the signal, only measurements that result in a positive range of the RSSI should be considered for a functional approximation. The approximation may be calculated by choosing the best fitted function given by determining and minimizing the parameters of a least square sum of the signal strength measurements.

With regard to media data exposure measurement, the preferred embodiment collects research data on a computer processing device, associates it with the collected Bluetooth signal characteristics, and (a) transmits the research data and Bluetooth signal characteristics to a remote server(s) (e.g., collection server 121) for processing, (b) performs processing of the research data and Bluetooth signal characteristics in the computer processing device itself and communicates the results to the remote server(s), or (c) distributes association/processing of the research data and Bluetooth signal characteristics between the computer processing device and the remote server(s).

Under another embodiment, one or more remote servers are responsible for collecting research data on media data exposure. When Bluetooth signal characteristics are received from a computer processing device, the signal characteristics are associated with the research data (e.g., using time stamps) and processed. This embodiment is particularly advantageous when remote media data exposure techniques are used to produce research data. One technique, referred to as “logfile analysis,” reads the logfiles in which a web server records all its transactions. A second technique, referred to as “page tagging,” uses JavaScript on each page to notify a third-party server when a page is rendered by a web browser. Both collect data that can be processed to produce web traffic reports together with the Bluetooth signal characteristics. In certain cases, collecting web site data using a third-party data collection server (or even an in-house data collection server) requires an additional DNS look-up by the user's computer to determine the IP address of the collection server. As an alternative to logfile analysis and page tagging, “call backs” to the server from the rendered page may be used to produce research data. In this case, when the page is rendered on the web browser, a piece of Ajax code calls to the server (XMLHttpRequest) and passes information about the client that can then be aggregated.

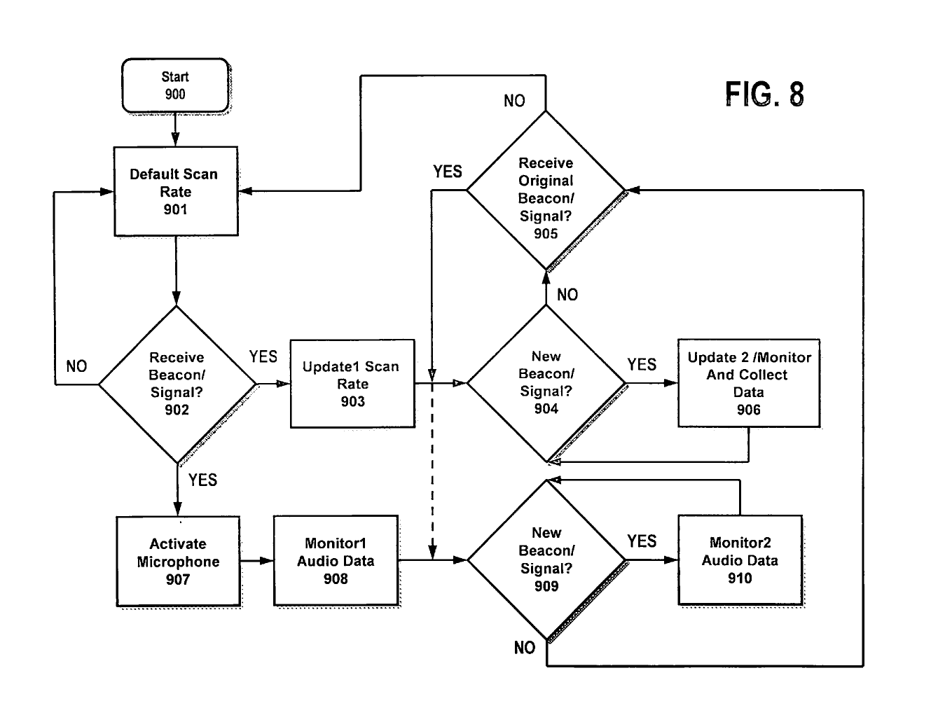

FIG. 6 is an exemplary embodiment of a portable computing device 700 which may function as a mobile terminal (e.g., see FIGS. 1 and 8, below), and may be a smart phone, tablet computer, or the like. Device 700 may include a central processing unit (CPU) 701 (which may include one or more computer readable storage mediums), a memory controller 702, one or more processors 703, a peripherals interface 704, RF circuitry 705, audio circuitry 706, a speaker 720, a microphone 721, and an input/output (I/O) subsystem 711 having display controller 712, control circuitry for one or more sensors 713 and input device control 714. These components may communicate over one or more communication buses or signal lines in device 700. It should be appreciated that device 700 is only one example of a portable multifunction device 700, and that device 700 may have more or fewer components than shown, may combine two or more components, or a may have a different configuration or arrangement of the components. The various components shown in FIG. 6 may be implemented in hardware or a combination of hardware and software, including one or more signal processing and/or application specific integrated circuits.

In one embodiment, decoder 710 serves to decode ancillary data embedded in audio signals in order to detect exposure to media. Examples of techniques for encoding and decoding such ancillary data are disclosed in U.S. Pat. No. 6,871,180, titled “Decoding of Information in Audio Signals,” issued Mar. 22, 2005, and is incorporated by reference in its entirety herein. Other suitable techniques for encoding data in audio data are disclosed in U.S. Pat. No. 7,640,141 to Ronald S. Kolessar and U.S. Pat. No. 5,764,763 to James M. Jensen, et al., which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

An audio signal which may be encoded with a plurality of code symbols is received at microphone 721, or via a direct link through audio circuitry 706. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 710 is capable of detecting codes in addition to those arranged in the formats disclosed hereinabove.

Alternately or in addition, processor(s) 703 can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO02/11123 to Wang, et al. and PCT publication WO91/11062 to Young, et al., all of which are incorporated herein by reference in their entireties. As discussed above, the code detection and/or signature extraction serve to identify and determine media exposure for the user of device 700.

In addition to audio-based media exposure monitoring, data-based, software-based and app-based media exposure monitoring may be performed on device 700. It is understood that media exposure data may include data relating to audio signatures, audio codes, cookies, and any other data indicating device usage characteristics pursuant to the presentation and/or reproduction of media on a device. Exemplary configurations may be found in U.S. Pat. No. 7,627,872 to Hebeler et al., titled “Media Data Usage Measurement and Reporting Systems and Methods” issued Dec. 1, 2009, which is assigned to the assignee of the present application and is incorporated by reference in its entirety here. Media exposure data may also include monitoring of device software usage and/or access, sometimes referred to as “app data.” Examples of such monitoring is described in U.S. patent application No. 13/001492, titled “Mobile Terminal And Method For Providing Life Observations And A Related Server Arrangement And Method With Data Analysis, Distribution And Terminal Guiding” filed Mar. 9, 2009, U.S. patent application No. 13/002205, titled “System And Method For Behavioural And Contextual Data Analytics,” filed Mar. 8, 2009, and Int'l Pat. Pub. No. WO 2011/161303 titled “Network Server Arrangement For Processing Non-Parametric, Multi-Dimensional Spatial And Temporal Human Behavior Or Technical Observations Measured Pervasively, And Related Method For The Same,” filed Jun. 24, 2010. Each of these documents is incorporated by reference in their entireties herein.

Under one embodiment media exposure data may be collected using media data usage gathering objects. Objects may serve to gather usage data for a single predetermined category of media data, such as graphical data, audio data, streaming media data, video data, text, web pages, image data, and the like. In this manner, each object preprocesses usage data by selecting the data based upon predetermined criteria. In certain embodiments, each object is dedicated to monitoring usage of media data of only one format, such as JPEG image data, AVI data, streaming media data to be reproduced by a certain player type, HTML, documents, BMP image data, etc. Media format may also include one or more techniques used to collect audio codes and/or audio signatures. In certain embodiments, each object is dedicated to monitoring usage of media data presented by means of only one type of user agent, such as a particular browser, player, etc. As new or different data formats and user agents become available, new or different objects and/or object classes may be provided to a processor (101) to enable monitoring thereof. The objects and object classes are preferably received by the processor via a network or other communication medium, or else from a storage medium. The monitoring capabilities are thus updated quickly and efficiently to keep pace with the ongoing, rapid evolution of media data formats and user agents.

In certain embodiments, data gathered by objects may represents media usage events such as the opening or closing of a user agent, a request for or receipt of new or different content or resource control location channel, scrolling, volume change, muting, onclick events, maximizing or minimizing a window, accessing software or apps, an interactive response to received content (such as a submission of a form or order), and/or the like. In other embodiments, an object may poll for predetermined media data state information, such as currently received content or currently accessed resource control location and/or the state of a user agent. Depending on the embodiment, an object may record either changes in state and/or the state itself. In further embodiments, an object may collect content metadata accompanying or associated with the media data. In other embodiments combinations of the foregoing are employed. In certain embodiments the attributes of an object include times or durations of the events or state information.

In certain embodiments an object may gather data at the board level (for example, a sound card 106), while in other embodiments it gathers data at the network level. In still other embodiments it gathers data at the operating system level (109), while in still further embodiments it gathers data at the application level 114 (for example, a player, viewer or other application). In yet still further embodiments, the object may gather data at two or more of the foregoing levels. Processor 101 may instantiate session objects which run within the processor or elsewhere in a user system for merging the media data usage gathering object into a respective session object which gathers data for a respective user session.

In certain embodiments the user session is defined by grouping media data usage gathering objects based on time or duration criteria. In various such embodiments, media data usage gathering objects representing usage (presentation or access) within each of predetermined time periods (such as dayparts or days) are grouped in corresponding user sessions. In other such embodiments, media data usage gathering objects representing one or more continuous and/or overlapping resource control location sessions are grouped in a single user session, while in further such embodiments media data usage gathering objects representing resource control location sessions separated in time by no more than a predetermined period are grouped into a single user session. In still other such embodiments combinations of the foregoing criteria are employed to group the objects into user sessions.

In other embodiments the user session is defined by grouping media data usage gathering objects based on indications of user activity. In various such embodiments, user inputs (for example, by means of a keyboard, keypad, pointing device, dial, remote control or touch screen, or an activity such as the insertion of prerecorded media in a disk drive or the like) are monitored to detect continuing user activity to determine the duration of a user session. In further embodiments, users are asked to indicate the beginning and/or the end of a user session.

In certain embodiments, one or more of the following attributes are included in the session objects: (1) “Session start”: the time that an RCL is first accessed by the user system and the media data is delivered thereto, or else when such media data is first presented to the user; (2) “Session stop”: the time that the user system ceases to access the RCL, or else when presentation of its media data to the user ceases; (3) “Session duration”: the duration of a user session, which may be measured as the length of time between Session start and Session stop; (4) “Session content”: the type and identity of the presented or accessed media data; (5) “Session interaction”: user interaction events occurring during a user session; (6) “Session content events”: media data events occurring during a user session; (7) “Session context”: system events occurring during a user session; (8) “Session metadata”: data describing the user session and any supporting data.

Report objects may be instantiated to merge session objects and/or other objects into itself, and/or to encapsulate data, for supply to one or more reporting systems for producing media usage reports. In certain embodiments, a report object may nerge one or more session objects representing the media data usage of a single user into a corresponding report object, while in others the object merges session objects into a report object representing media data usage by multiple identified users. In certain embodiments a report object may nerge one or more session objects representing media data usage within a predetermined time span, while in other embodiments report object merges session objects in response to a request from a reporting system coupled with user device or system either through the network or via a different communication medium.

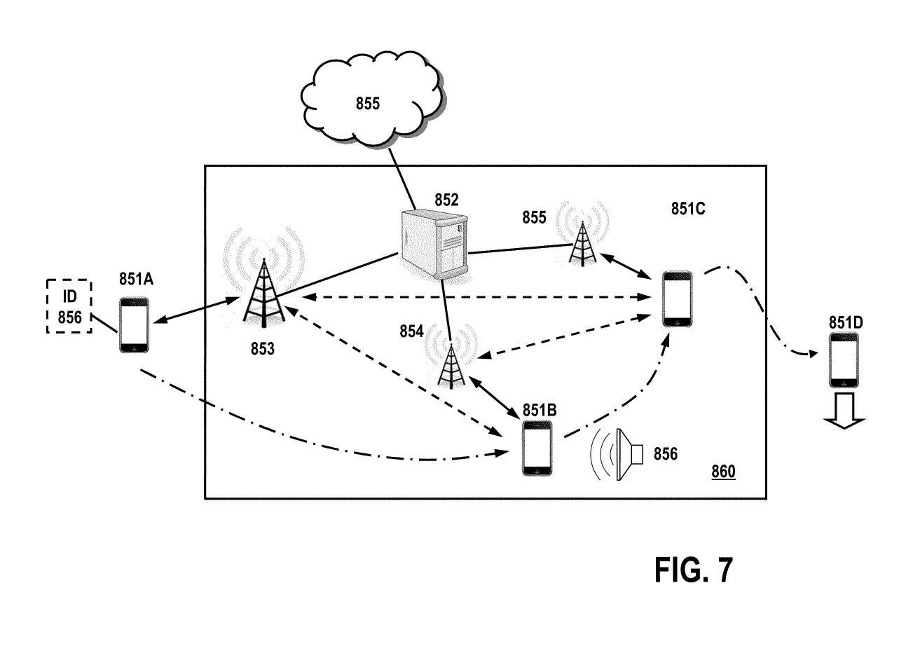

Continuing with FIG. 7, memory 708 may include high-speed random access memory (RAM) and may also include non-volatile memory, such as one or more magnetic disk storage devices, flash memory devices, or other non-volatile solid-state memory devices. Access to memory 708 by other components of the device 700, such as processor 703, decoder 710 and peripherals interface 704, may be controlled by the memory controller 702. Peripherals interface 704 couples the input and output peripherals of the device to the processor 703 and memory 708. The one or more processors 703 run or execute various software programs and/or sets of instructions stored in memory 708 to perform various functions for the device 700 and to process data. In some embodiments, the peripherals interface 704, processor(s) 703, decoder 710 and memory controller 702 may be implemented on a single chip, such as a chip 701. In some other embodiments, they may be implemented on separate chips.

The RF (radio frequency) circuitry 705 receives and sends RF signals, also called electromagnetic signals. The RF circuitry 705 converts electrical signals to/from electromagnetic signals and communicates with communications networks and other communications devices via the electromagnetic signals. The RF circuitry 705 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 705 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 706, speaker 720, and microphone 721 provide an audio interface between a user and the device 700. Audio circuitry 706 may receive audio data from the peripherals interface 704, converts the audio data to an electrical signal, and transmits the electrical signal to speaker 720. The speaker 720 converts the electrical signal to human-audible sound waves. Audio circuitry 706 also receives electrical signals converted by the microphone 721 from sound waves, which may include encoded audio, described above. The audio circuitry 706 converts the electrical signal to audio data and transmits the audio data to the peripherals interface 704 for processing. Audio data may be retrieved from and/or transmitted to memory 708 and/or the RF circuitry 705 by peripherals interface 704. In some embodiments, audio circuitry 706 also includes a headset jack for providing an interface between the audio circuitry 706 and removable audio input/output peripherals, such as output-only headphones or a headset with both output (e.g., a headphone for one or both ears) and input (e.g., a microphone).

I/O subsystem 711 couples input/output peripherals on the device 700, such as touch screen 715 and other input/control devices 717, to the peripherals interface 704. The I/O subsystem 711 may include a display controller 712 and one or more input controllers 714 for other input or control devices. The one or more input controllers 714 receive/send electrical signals from/to other input or control devices 717. The other input/control devices 717 may include physical buttons (e.g., push buttons, rocker buttons, etc.), dials, slider switches, joysticks, click wheels, and so forth. In some alternate embodiments, input controller(s) 714 may be coupled to any (or none) of the following: a keyboard, infrared port, USB port, and a pointer device such as a mouse, an up/down button for volume control of the speaker 720 and/or the microphone 721. Touch screen 715 may also be used to implement virtual or soft buttons and one or more soft keyboards.

Touch screen 715 provides an input interface and an output interface between the device and a user. The display controller 712 receives and/or sends electrical signals from/to the touch screen 715. Touch screen 715 displays visual output to the user. The visual output may include graphics, text, icons, video, and any combination thereof (collectively termed “graphics”). In some embodiments, some or all of the visual output may correspond to user-interface objects. Touch screen 715 has a touch-sensitive surface, sensor or set of sensors that accepts input from the user based on haptic and/or tactile contact. Touch screen 715 and display controller 712 (along with any associated modules and/or sets of instructions in memory 708) detect contact (and any movement or breaking of the contact) on the touch screen 715 and converts the detected contact into interaction with user-interface objects (e.g., one or more soft keys, icons, web pages or images) that are displayed on the touch screen. In an exemplary embodiment, a point of contact between a touch screen 715 and the user corresponds to a finger of the user. Touch screen 715 may use LCD (liquid crystal display) technology, or LPD (light emitting polymer display) technology, although other display technologies may be used in other embodiments. Touch screen 715 and display controller 712 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 712.

Device 700 may also include one or more sensors 716 such as optical sensors that comprise charge-coupled device (CCD) or complementary metal-oxide semiconductor (CMOS) phototransistors. The optical sensor may capture still images or video, where the sensor is operated in conjunction with touch screen display 715. Device 700 may also include one or more accelerometers 707, which may be operatively coupled to peripherals interface 704. Alternately, the accelerometer 707 may be coupled to an input controller 714 in the I/O subsystem 711. The accelerometer is preferably configured to output accelerometer data in the x, y, and z axes.

In some embodiments, the software components stored in memory 708 may include an operating system 709, a communication module 710, a contact/motion module 713, a text/graphics module 711, a Global Positioning System (GPS) module 712, and applications 714. Operating system 709 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 710 facilitates communication with other devices over one or more external ports and also includes various software components for handling data received by the RF circuitry 705. An external port (e.g., Universal Serial Bus (USB), Firewire, etc.) may be provided and adapted for coupling directly to other devices or indirectly over a network (e.g., the Internet, wireless LAN, etc.

Contact/motion module 713 may detect contact with the touch screen 715 (in conjunction with the display controller 712) and other touch sensitive devices (e.g., a touchpad or physical click wheel). The contact/motion module 713 includes various software components for performing various operations related to detection of contact, such as determining if contact has occurred, determining if there is movement of the contact and tracking the movement across the touch screen 715, and determining if the contact has been broken (i.e., if the contact has ceased). Text/graphics module 711 includes various known software components for rendering and displaying graphics on the touch screen 715, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 712 determines the location of the device and provides this information for use in various applications. Applications 714 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication.

Turning to FIG. 7, embodiments are disclosed for utilizing wireless signals to configure wireless devices, preferably in the area of public places, such as shopping malls, stores, public events, and the like, for gathering research data. In one embodiment, public area 860 comprises at least one higher-range antenna 853 (e.g., class 1, up to 100 meters), together with a plurality of lower-range antennas 854, 855 (e.g., class 2, up to 30 meters) that are communicatively coupled to processor 852. Processor 852 may be a dedicated server, a terminal coupled to one or servers in network 855, or any other suitable device. Processor 852 is capable of sending/receiving data through any or all antennas 853-855. Preferably, processor 852 is configured to independently send and/or receive data through all connected antennas. Processor 852 may further send and/or receive data from network 855 via a dedicated connection such as TCP/IP.

Preferably, each antenna (transmitter/transceiver) in FIG. 7 supplies its own piconet for connecting devices, and the antennas may be operatively coupled together to form one or more scatternets in area 860. Each device initiates its own entry into an existing piconet by forming a scatternet with the master. Cross-piconet communication can take place without requiring devices to periodically disconnect from one piconet and reconnect to the other. Devices can also participate in store-and-forward messaging, effectively removing any Bluetooth range limits if enough devices are available to relay data. When operating in a scatternet, devices may multiplex between piconets to prevent timeouts. If a device is involved only in ACL traffic across piconets, it can use sniff, hold and park low-power modes to divide its attention between different piconets. If a slave device is a member of two or more piconets, an offsetting sniff interval (e.g., every X slots) may be used to multiplex traffic between piconets. This sniff interval would enable symmetric switching to allow a device to divide its time between different piconets. Additionally a predetermined hold time may be implemented for active piconet connections so that the device could sniff and connect with other piconets.

Instead of using sniff intervals to multiplex between piconets, devices may use the hold and park modes between piconets, although the hold mode may slow switching rates between piconets as this would require a device to hold an active piconet and renegotiate a hold in another piconet before returning to exchange more ACL packets. Preferably, a park mode is used for scatternet members, as this mode provides greater versatility for monitoring piconets for unpark commands and other broadcast packets, and may skip several beacon trains by utilizing a sleep time interval (N_{Bsleep}) that is a multiple of beacon interval lengths. This effectively allows a device to offset beacon monitoring times, similar to the sniff mode discussed above. Alternately, a device (acting as a slave in the scatternet), can simply ignore each piconet in turn without informing the respective masters of its temporary exit; as long as the timeout periods are not exceeded, the links should be maintained under normal operating conditions

During a set-up process, each of antennas 853-855 are provided a unique identification or hash that is communicated each time a wireless connection is made with a device (e.g., via module 705 illustrated in FIG. 6). Device 851A preferably stores a list of antenna ID's 856, that may be supplied via a wireless global “push,” or alternately provided by a local wireless source, such as long-range antenna 853. ID information 856 may be used by device 851A to identify specific antennas for adjusting operational characteristics. For the purposes of clarification, FIG. 7 illustrates an example of a device (851) being carried through an area 860 at four discreet locations, involving four different events; each of these locations/events for the device are designated as 851A-851D, respectively. It is understood that, in addition to receiving a wireless signal and ID, additional information may be provided in the wireless signal, such as messages or commands. Each antenna may have specific messages or commands that may be sent to the device and processed within the device to modify the operational characteristics described herein.

In the embodiment of FIG. 7, device 851A is physically carried by a user through public area 860. Prior to entering area 860, device 851A is arranged to have a default configuration where, in one embodiment, a predetermined wireless scan rate is set (e.g., once every 5 minutes) and an audio capture capabilities are set to “OFF.” As device 851A approaches area 860, it comes into communication range with long-range antenna 853. In the case of Bluetooth communication, antenna 853 is configured to be the master. Once initial communication is established, antenna 853 transmits its ID to device 851A, and the ID is compared to a stored ID to determine if there is a match. Once the ID is matched, this triggers device 851A to update scanning intervals to a higher frequency (e.g., once every 30 seconds) as device 851A enters area 860. Once inside area 860, the device moves to 851B, where it now establishes communication with antenna 854, where it may now form a scatternet together with antenna 853. Again, if the ID for antenna 854 is matched, a new operation may be triggered or an existing operation may be further updated. In this example, the ID received from antenna 854 causes device 851B to activate processes on the device via software and/or hardware. In one embodiment, audio processing is activated (e.g., via DSP/decoder 710 and microphone 721 of FIG. 6) to activate audio processing on the device to detect ancillary code in audio and/or extract audio signatures. Such a configuration is particularly advantageous in an area where detection of audio media exposure is important; once the activation is completed, device 851B is able to collect research data pertaining to audio 856 or an audio component of other media in the vicinity of 854. Additionally, environmental audio signatures may be extracted to establish and/or confirm the location of device 851B. Techniques for collecting and processing environmental audio signatures is described in U.S. patent application Ser. No. 13/341,453, titled “System and Method for Determining Contextual Characteristics of Media Exposure Data” filed Dec. 30, 2011, which is assigned to the assignee of the present application and is incorporated by reference in its entirety herein.

As device approaches 851C, it next establishes communication with antenna 855 and receives the antenna ID. If the ID matches, device 851C further updates the operating characteristics. In this example, the ID match may trigger device 851C to turn off audio monitoring. Additionally, the ID match from 855 may further update the scanning mode of device 851C to scan for wireless connections more or less frequently. As device 851D moves outside area 860, it eventually loses its wireless connection to the antennas and as a result, reverts back to a default mode of operation.

Turning to FIG. 8, an exemplary flowchart is provided, where, after a portable device powers up, the process begins at 900. At this point, the portable device is preferably set to a default configuration, where a wireless network scan rate is set to a default rate 901. The device periodically monitors to see if the device has receives a beacon or signal in 902, where, if no beacon or signal is received, the device retains its default scan rate 901. However, once a beacon or signal is detected, the scan rate is updated in 903 to a more or less frequent rate. Additionally or alternately, the detection of a beacon or signal in 902 may activate the devices DSP and/or microphone capabilities in 907, where the device would begin an audio monitoring process utilizing codes and/or signatures, described above.

As the scan rate is updated in 903, the device continues to monitor if a new beacon or signal is received in 904. If a new beacon or signal is not received, the device checks to see if the original beacon is being received in 905. If the original beacon or signal is not being received, the device reverts back to a default scan rate in 901. However, if the original beacon or signal is still being received, the device maintains the updated scan rate (903) and continues to monitor for new beacons or signals. As an example, device 851A of FIG. 7 may establish a connection with long-range antenna 853 while moving past area 860, but the device does not enter area 860. As a result, no further connections will be made with antennas 854-855. Once device 851A moves outside the communication range of 853, the beacon or signal will be lost and device 851A simply reverts back to its default mode of operation. However, as device 851A enters area 860, it is possible for device 851A to be in a section of area 860 that does not contain shorter-range antennas, or is not yet within range of antennas 854 or 855. In such a case, the device will maintain the updated scan rate until a new beacon or signal is received. Once a new beacon or signal is received in 904 (e.g., from antenna 854), the scan rate is updated again in 906 and further data may be collected. This process may repeat for each new beacon or signal (e.g. 855) until the device exits the area and no beacons or signals are detected.

In step 902, a detected beacon or signal may also activate the device's DSP and/or microphone 907 whereupon the device begins reading ancillary code or extracting signatures from audio 908. If a new beacon or signal is detected in 909 (note: the beacon or signal in 909 may be the same beacon or signal as 904), the audio monitoring configuration is updated in 910. In one embodiment, the audio monitoring update may involve such actions as (1) modifying the characteristics of code detection (e.g., frequencies used, timing, etc.), (2) switching the monitoring from detecting code to extracting signatures and vice versa, (3) switching the method of code detection from one type to another (e.g., from CBET decoding to spread-spectrum, from echo-hiding to wavelet, etc.), (4) switching the method of signature extraction from one type to another (e.g., frequency-based, time-based, a combination of time and frequency), and/or (5) providing supplementary data that is correlated to the audio monitoring (e.g., location, other related media in the location, etc.). Similar to the scanning portion described above, if no additional beacons are detected in 909, the device looks to see if the original beacon or signal is being received. If not, the device reverts back to its original configuration and may turn off audio monitoring. If the original beacon is signal is still being detected, the device maintains its current (updated) audio monitoring configuration and continues to monitor for new beacons or signals. Also, the process for audio monitoring repeats for each new beacon or signal no beacons or signals are detected.

It is understood that the embodiments described above are mere examples, and that the disclosed configurations allow for a multitude of variations. For example, the ID detection may be combines with signal strength measurements described above to allow additional modifications, where scan rates may be incrementally increased or decreased as the signal strength becomes stronger or weaker. Also, scan rates and/or audio monitoring may be triggered only when signal strength exceeds a predetermined threshold. Furthermore, device triggers may be made dependent upon combinations of antenna connections. Thus, connections to a 1^{st} and 2^{nd} beacon would produce one modification on the device, while a connection to a 1^{st}, 2^{nd} and 3^{rd} beacon would produce a new, alternate or additional modification. If the connection to the 2^{nd} beacon is lost (leaving a connection only with the 1^{st} and 3^{rd} beacon), yet another new, alternate or additional modification could be produced. Many such variations may be made under the present disclosure, depending on the needs of the system.

In addition to modifying a mode of operation, the present disclosure further allows for location information to be incorporated, for example, as device 851 is carried through various public areas (860). In one simplified embodiment, each antenna (853-855) contains an associated ID that is captured at the time device 851 comes within communication range, and regardless of whether or not a connection is actually made. In another embodiment, the antenna ID may be captured when device 851 is in communication range, and a further antenna ID is transmitted to the device when a connection is made. In another embodiment, antenna IDs are correlated to their transmission range. Thus, WiFi antenna IDs would be grouped and processed differently from Bluetooth antenna IDs. In this manner, WiFi IDs would be associated with a general location (e.g., mall, areas of a mall), and Bluetooth IDs would be associated with specific locations (e.g., a store/kiosk within a mall). As a user moves about an area, the IDs are collected in the device and later processed to determine locations visited within a predetermined period of time. This configuration is particularly advantageous when it is used in conjunction with media exposure data and even web analytics. For example, as media exposure data is collected from a device, it may be determined via audio signatures and/or audio codes that the device was exposed to particular content, such as a commercial for a store. By retrieving the location data from the device, it may be determined what locations the device was near within a given period of time (e.g., day, week, month, etc.). In addition, GPS data may be also combined to determine location, particularly in instances where locations are outdoors.

The location system described above may be compatible with the Open Geospatial Consortium (OGC) Web Feature Service Interface Standard (WFS) and Open Location Services Interface Standard (OpenLS), utilizing Geography Markup Language (GML). To the extent mapping functions may be carried out, Geographic Information Systems (GIS) may serve as data providers for geographic information, particularly for outdoor monitoring. Web mapping applications, such as OpenStreetMap or Google Maps are available to access geographic data such as street maps and satellite imagery, and may be accessed using APIs to perform functions such as searching or routing. The Open Geospatial Consortium specifies interfaces and protocols that may be constructed in accordance with OGC guidelines to support interoperability functions for accessing spatial information and providing location-based services. The Web Map Service is an OGC standard for offering geo-referenced map data as raster images. The Web Feature Service is a service to provide geographic features (map data, metadata, vectors) encoded in XML. Such services may be accessed via HTTP.

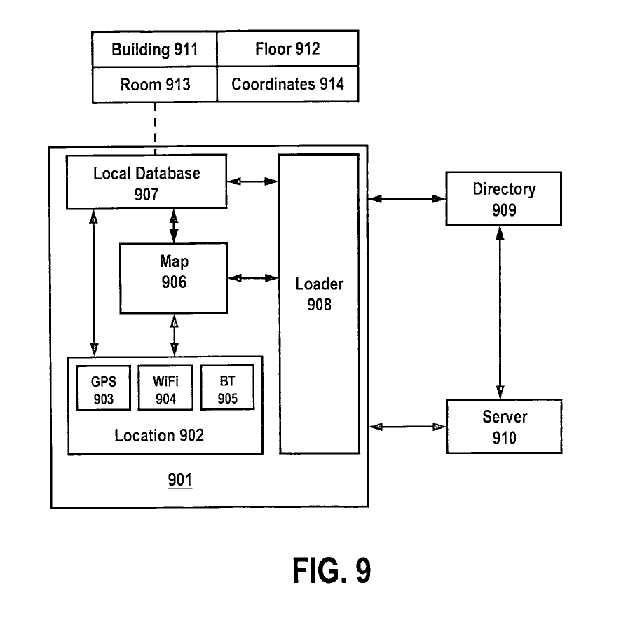

Location and mapping features are particularly advantageous for outdoor location tracking, but have limitations for indoor tracking, where GPS signals may be too weak to be useful. Accordingly, indoor location tracking would be necessary to fully track user movements. Turning to FIG. 9, an exemplary embodiment is provided for location tracking, where processing device 901 contains a location module 902 that receives data relative to GPS 903, WiFi 904 and Bluetooth 905 readings. As mentioned above, GPS readings 903 may be used to track outdoor movements, and will not be discussed further in connection with FIG. 9. WiFi signals 904 may be particularly useful in location tracking, as WiFi is commonly available in public areas. Wi-Fi-enabled devices can be located by applying one of two types of location-sensing techniques: one based on propagation and another based on location fingerprinting (or “wireless fingerprinting”). Propagation-based techniques measure the received signal strength (RSS), angle of arrival (AOA), or time difference of arrival (TDOA) of received signals and may apply models to determine the location of the device.

Location fingerprinting allows locating a device by using RSS and coordinates of other devices within a Wi-Fi footprint and calculating coordinates for location by comparing the signal with the location fingerprinting database. Location fingerprinting may be executed using an off-line and online stage. During the offline stage, a site survey performed in the target area is performed. RSSs are collected at sampling locations to build a database (radio map) as a function of the user's physical coordinates. During the online stage, the positioning techniques measure RSS in real time by the receiver and calculate the estimated location coordinates based on the previously recorded database of RSSs stored in the database. Location estimation is preferably applied to more accurately determine location (due to RSS susceptibility to the multipath effect), and various machine learning techniques may be applied, including a probabilistic location estimation, K-nearest-neighbor estimation, neural networks, and support vector machines. For probabilistic location estimation, one particular embodiment utilizes statistical parameters extracted from the radio map to estimate the location. Kernel canonical correlation analysis may also be used to construct a more accurate mapping function between RSS and radio map. In one advantageous embodiment, Kalman Filter may be utilized to track multiple points to characterize a trajectory, which can increase the accuracy further. Further details regarding Kalman filters may be found in Greg Welch & Gary Bishop, “An Introduction to the Kalman Filter,” TR 95-041 Department of Computer Science University of North Carolina at Chapel Hill, 2006.

Continuing with FIG. 9, WiFi location data 904 may be supplemented with Bluetooth location data 905, and vice versa for more accurate location tracking. In one embodiment, WiFi location data is measured independently from Bluetooth location data, and the two measurements are merged in a database. As Bluetooth signals communicate at much shorter ranges, they may be arranged in the database to take precedence over WiFi location signals, in the event two location measurements exist for a given time period. In another embodiment, WiFi location fingerprints are collected until a Bluetooth beacon is detected, at which time the WiFi location tracking “hands off” location data collection to the Bluetooth connection. Once the Bluetooth signal is no longer detected, the WiFi antenna continues to collect location fingerprints.

Location data in 902 is preferably correlated to map database 906 and local database 907. The map database 906 preferably stores maps for given geographic locations, while local database 907 stores information about local regions for a geographic location. Thus, as an example, map database 906 may contain city and street-level information, while local database may contain information pertaining to a building 911, floor, 912, room 913 or coordinates 914. Under a preferred embodiment, local database 907 correlates to WiFi and Bluetooth location mapping, while map database 906 correlates to GPS location mapping.

Specific maps for mapping location data may be loaded via loader 908, which communicates over a network to server 910, which may contain building information and the like. Server 910 may be provisioned with a Web Feature Service that supports various raster and vector data formats, geographic data sources and OGC standards (e.g., WMS, WFS, GML, etc.). Server 910 communicates with directory service 909. Under a preferred embodiment, directory service may be based on the OpenLS Directory Service standard and provides interfaces for registering and looking up resources with World Geodetic System 1984 (WGS84) coordinates and further attributes. Directory service 909 may be based on Apache Tomcat, MySQL and JSP. Under one embodiment, requests are processed to parse XML requests, extract a geo-window, and query the database to get all available building servers in an area.

During operation, loader 908 may perform a lookup at directory service 909 to discover building servers in the given area. Based on the lookup results, loader retrieves any stored building data, or requests data from server 910. For newly discovered buildings, loader 908 may request generalized information regarding the building (e.g., building outline) and any available positioning information. Further data and the layers for positioning technologies supported by the device are downloaded on follow-up requests, and may be when a device is in close proximity to a building or by user interactions.

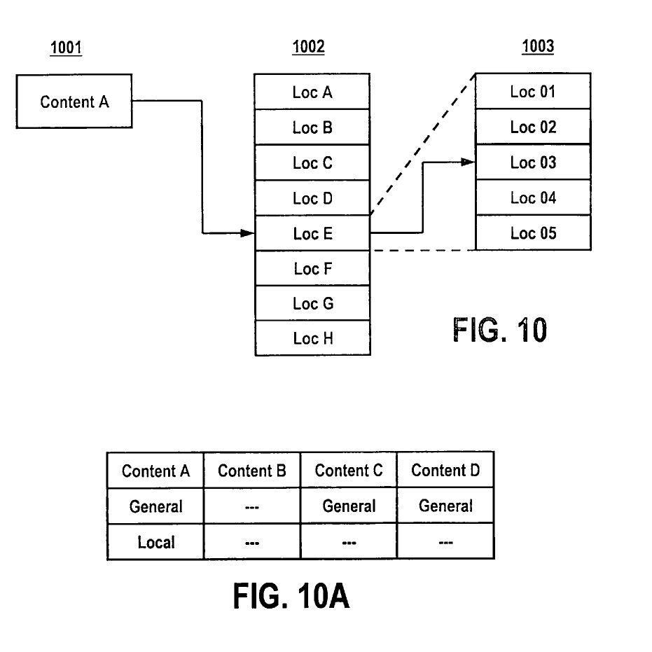

Turning now to FIG. 10, an exemplary embodiment is provided, where media exposure and location linking is illustrated. In this example, it is determined 1001 that a device (700) has been exposed to “Content A,” which may be an audio and/or visual commercial, program and the like. For the purposes of this example, “Content A” is a commercial for a particular sporting goods item. Over the course of a predetermined period of time (e.g., a week), the device was wirelessly sensed 1002 to be at 8 locations (Loc A-H). Of these locations, location “Loc E” is known to be a building containing a sporting goods store, where the store is located in “Loc 03” of the building. If the user carrying the device walks into or is within proximity of the store 1003, his presence (“Loc 03”) is registered. Additionally, other locations (Loc 01-02, Loc 04-05) were registered as well.

It should be understood that the present disclosure provides a powerful tool for correlating and reporting media exposure with user actions. In the example of FIG. 10, since all wirelessly sensed locations are registered, this provides opportunities for audience measurement entities to cross-correlate location presence to commercial establishments with media exposure. If the user was exposed to a sporting goods commercial, but did not physically visit a sporting goods store, valuable information may still be determined via cross-correlating the other locations visited. There correlations and other observations discussed above may subsequently be communicated in reports that may be transmitted electronically as is known in the art. For example, it may be determined that 45% of users exposed to the sporting goods commercial visited an auto body shop, or 64% of users exposed to a particular radio or television program visited a local mall within 24 hours of watching the program. In the embodiment show in FIG. 10A, locations may be classified to indicate a general (or “gross”) visit to a location, or a local (or “direct”) visit. In this example, a general visit would indicate a physical presence at or near a building, while a local visit would indicate a physical presence within a specific part of the building. As shown in FIG. 10A, a correlation map is illustrated for Content A-D, where a general and local presence was determined for a location related to Content A, while only a general presence was detected for Contents C and D.

While at least one exemplary embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A computer-implemented method for correlating media exposure data with location data for a portable processing device, comprising the steps of:
receiving the media exposure data in a processing device, the media exposure data representing media that was one of received and reproduced on or near the portable processing device;
processing the media exposure data to determine at least one characteristic of the media;
receiving location data from the portable processing device over a predetermined time period, wherein the location data is based on radio wave measurements;
processing the location data to determine at least one identification for at least some of the location data; and
processing the identification in the processing device to determine a correlation between the at least one identification and the determined characteristic.

2. The computer-implemented method of claim 1, wherein the media exposure data comprises at least one of (i) ancillary code relating to audio, (ii) audio signatures, (iii) exposure to Internet data, (iv) exposure to metadata, (v) portable device usage data.

3. The computer-implemented method of claim 1, wherein the location data is based on location fingerprinting of WiFi signals.

4. The computer-implemented method of claim 3, wherein the location comprises building data.

5. The computer-implemented method of claim 5, wherein the location data comprises at least one of floor data, room data and coordinate data.

6. The computer-implemented method of claim 1, further comprising the steps of receiving second location data based on Global Positioning System (GPS) measurements.

7. The computer-implemented method of claim 1, wherein the predetermined time period is subsequent to a time period in which the media was one of received and reproduced on the portable processing device.

8. The computer-implemented method of claim 7, wherein the characteristic of the media comprises a subject matter of the media.

9. The computer-implemented method of claim 8, wherein the at least one identification comprises an identification of a commercial establishment.

10. The computer-implemented method of claim 9, further comprising the step of generating a report identifying the correlation between the subject matter of the media and the identification of the commercial establishment.

11. A system for correlating media exposure data with location data for a portable processing device, comprising:
an input for receiving the media exposure data, the media exposure data representing media that was one of received and reproduced on or near the portable processing device, wherein the input is configured to receive location data from the portable processing device over a predetermined time period, wherein the location data is based on radio wave measurements;
a processor, operatively coupled to the input, said processor being configured to:
process the media exposure data to determine at least one characteristic of the media;
process the location data to determine at least one identification for at least some of the location data; and
process the identification to determine a correlation between the at least one identification and the determined characteristic.

12. The system of claim 1, wherein the media exposure data comprises at least one of (i) ancillary code relating to audio, (ii) audio signatures, (iii) exposure to Internet data, (iv) exposure to metadata, (v) portable device usage data.

13. The system of claim 1, wherein the location data is based on location fingerprinting of WiFi signals.

14. The system of claim 3, wherein the location comprises building data.

15. The system of claim 5, wherein the location data comprises at least one of floor data, room data and coordinate data.

16. The system of claim 1, wherein the input is configured to receive second location data based on Global Positioning System (GPS) measurements.

17. The system of claim 1, wherein the predetermined time period is subsequent to a time period in which the media was one of received and reproduced on or near the portable processing device.

18. The system of claim 7, wherein the characteristic of the media comprises a subject matter of the media.

19. The system of claim 8, wherein the at least one identification comprises an identification of a commercial establishment.

20. The system of claim 9, further comprising the step of generating a report identifying the correlation between the subject matter of the media and the identification of the commercial establishment.
